(19) United States
(12) Patent Application Publication
(10) Pub. No.: US 2021/0213989 A1
(43) Pub. Date: Jul. 15, 2021

(54) Shopper's Pouch

(71) Applicants: John E. Petrick, Bedford, NY (US); Patricia K. Petrick, Bedford, NY (US)

(72) Inventors: John E. Petrick, Bedford, NY (US); Patricia K. Petrick, Bedford, NY (US)

(21) Appl. No.: 17/190,780

(22) Filed: Mar. 3, 2021

Related U.S. Application Data
(63) Continuation-in-part of application No. 16/743,789, filed on Jan. 15, 2020.

(51) Int. Cl. B62B 3/14; B62B 5/00

(52) U.S. Cl. CPC B62B 3/1464; B62B 5/00

(57) ABSTRACT

A shopper's pouch comprising at least two sections selected from a front, a rear, a side(s) and a lower section, each with inner and outer surfaces. The front and rear sections can be equally dimensioned and integrally secured together with the lower section, thereby creating an enclosure into which items such as re-usable shopping bags can be inserted and maintained. The shopper's pouch is permanently or removably secured to a shopping cart preferably at the front of the cart. A viewing window or viewing structure facilitates the displaying advertising or promotional material on the pouch. An opening on the viewing window or structure allows the advertising or promotional material to be easily inserted for display or to be removed and replaced. In addition to the advertising and promotional material indicia showing words or images can be printed or placed on the pouch.

### TECHNICAL FIELD

The invention generally pertains to bags and other carrying devices, and more particularly to a pouch that is permanently secured to a shopping cart.

### BACKGROUND ART

Although online and delivery services for purchasing groceries or other items is popular, many people still prefer to go to a supermarket or other store and purchase items in-person. After purchasing items, especially when there are multiple items, a person or store clerk will typically place the items in a bag for easy carrying of the items. In recent years, as a result of a significant increase in the need for recycling and green living, many local and state governments have banned the use of non-recyclable bags, requiring shoppers to bring their own re-usable bags, usually made of polypropylene or fabric, thereby reducing the amount of trash from discarded bags.

While this effort is well-intentioned, many people find it difficult to use their own re-usable bags. A major part of this problem is that the empty re-usable bags can be quite large even when empty and must be carried during shopping. For a person who purchases many items, there is the need for a number of bags. Even if folded it is still awkward to carry the bags while also pushing a shopping cart and selecting items for purchase. As a solution some people drop the re-usable bags into their shopping cart basket often resulting in less space for selected items to be purchased resulting in bags and items mixed together and an unorganized mess at checkout.

What is needed is a means by which re-usable shopping bags, or other items, can be conveniently maintained and carried with a person who is shopping. Optimally, an enclosure would be permanently secured to a shopping cart for maintaining the bags or items in a hands free but quickly accessed location for use by all shoppers.

A search of the prior art did not disclose any literature or patents that read directly on the claims of the instant invention. However, the following U.S. patents are considered related:

| PATENT NO. | INVENTOR | ISSUED |
|---|---|---|
| 4,871,100 | Posner | Oct. 3, 1989 |
| 10,272,938 | Finley | Apr. 30, 2019 |
| 2004/0208397 | Yi | Oct. 21, 2004 |
| 2006/0097467 | Solomon | May 11, 2006 |
| 2010/0219219 | Svetina | Sep. 2, 2010 |

The U.S. Pat. No. 4,871,100 discloses a shopping bag for use with a supermarket shopping cart and that has a rectangular base and foldable sides with stiff upper edges for hooking over the sides of the basket ofthe cart.

The U.S. Pat. No. 10,272,938 discloses a shopping cart accessory pouch that includes a flexible base including a front wall, a rear wall, a pair of sidewalls and a pair of central dividing walls. The dividing walls separate an interior of the base into a front compartment and a rear compartment. A central pocket is used for receiving items such as coupons or other thin objects. A plurality of attachment fasteners are configured to secure the base to a rail of a shopping cart. The pouch is configured to provide storage space that is above the lower surface of the shopping cart.

The 2004/0208397 publication discloses a shopping bag which is attachable to a cart for carrying items in a shop. The bag includes a handle frame having at least two fixing frames attached to both handle frames of a shopping bag for thereby fixing the shopping bag to a cart. A coin storing member for storing a coin in the handle frame of a shopping bag with the coin used for unlocking a cart from a locked state. Velcro tape is attached to an upper side of the shopping bag for closing the shopping bag.

The 2006/0097467 publication discloses a shopping cart that supports shopping bag dispenser(s) to enable shoppers to package goods as they shop. The dispensers may be connected to fixtures that support goods to enable shoppers to obtain shopping bags while shopping.

The 2010/0219219 publication discloses a shopping bag container (SBC) that is releasably attached to a structural member on a shopping car. The SBC is comprised of an inner section, an outer section and an expandable divider between the sections. The divider is comprised of an accordion structure that allows the SBC to be either flat or expanded. When the accordion structure is expanded, shopping bags can be inserted and stored in the SBC.

For background purposes and indicative of the art to which the invention relates, reference may be made to the following remaining patents found in the patent search.

| PATENT NO. | INVENTOR | ISSUED |
|---|---|---|
| 6,056,178 | Rapp-Duncan | May 2, 2000 |
| 5,002,245 | Hansen et al | Mar. 26, 1991 |
| 4,096,994 | Wharmby | Jan. 24, 1978 |
| 3,861,633 | Rappleye | Jan. 21, 1975 |
| 3,861,630 | Ady | Jan. 21, 1975 |
| 3,479,085 | Weinstein | Nov. 18, 1969 |
| 2,582,650 | Patton | Jan. 15, 1952 |
| 2,507,842 | Waddill | May 16, 1950 |
| 1,656,339 | Runyan | Jan. 17, 1928 |
| 396,561 | Harrison | Jan. 22, 1889 |

### DISCLOSURE OF THE INVENTION

In its basic design, the shopper's pouch is comprised of a front section with an inner surface and an outer surface, a back section with an inner surface and an outer surface, and a lower section. The three sections are either integrally secured together or secured together by attachment means. The three secured sections effectively form an enclosure similar to a bag. An opening that is preferably located on the upper edge of the pouch facilitates the insertion of items into the pouch. An upper flap can be included to cover the opening, thus providing a way of closing the pouch.

The shopper's pouch is designed to be permanently or removably secured onto a shopping cart. The pouch is preferably secured to the front of a shopping cart, although the pouch could also be secured to the rear or one of the sides of a shopping cart. Also, if desired or required, multiple pouches can be secured at various locations on a single shopping cart. The principal purpose of the shopper's pouch is to provide a means by which items can be maintained and carried with a person who is shopping at a supermarket or other location. The shopper's pouch is especially effective for maintaining re-usable shopping bags into which items are placed after being purchased. Re-usable shopping bags are typically carried, randomly placed within a shopping cart, or left in a vehicle when a person is shopping. The shopper's pouch allows re-usable shopping bags, or other items, to be maintained in a location that is convenient, clean and allows easy access to the bags or items when they are needed.

The shopper's pouch can be made of various materials such as a fabric, plastic, cardboard, mesh material or even metal. The pouch is secured to a shopping cart by attachment means or a device that can include an adhesive, screws, bolts and nuts, pins, male and female detents or staples. The shopper's pouch is preferably square shaped, although other shapes such as circular, oval or rectangular can also be utilized.

To increase the functionality of the shopper's pouch, and to provide a source of revenue, the shopper's pouch can include advertising or promotional materials. Either an integral viewing window, or a separate viewing structure, is an element of the pouch and allows the advertising or promotional material to be easily placed and maintained on the pouch. Once the material is inserted into the viewing window or viewing structure, the material is effectively visible for viewing by both a person using a shopping cart, and from other people who pass or are otherwise in close proximity to the shopping cart. Additionally, used either with or without the viewing window or structure, the shopper's pouch can include indicia located on the surfaces of the pouch. The indicia, which is typically permanent, can consist of any words or images, and provide an aesthetic or functional addition to the pouch.

The shopper's pouch is primarily disclosed as a flexible, malleable structure, but in alternate combinations, and especially when made of a material such as plastic or metal, the shopper's pouch can be a rigid structure. For any of the configurations, either a fluid resistant coating can be applied onto the pouch, or the pouch can be made of a fluid resistant material, and/or an anti-microbial agent can be applied onto the pouch.

When considering the various design configurations of the shoppers pouch, two of the most viable designs are a rigid, square/rectangular structure with a front section, a right side wall, a left side wall and a lower surface, and a rigid structure with a one-piece convex front section and a lower surface, both of these designs can be easily permanently or non-permanently secured to a shopping cart and are particularly robust.

In view of the above disclosure, the primary object of the invention is to provide a shopper's pouch that is permanently secured to a shopping cart and provides a person with quick and easy access to items such as re-usable shopping bags, purses, wireless devices and/or car keys, as well as providing a platform by which advertising or promotional materials and indicia can be displayed.

In addition to the primary object, it is also an object of the invention to provide a shopper's pouch that:
is easy to use,
is inexpensive to produce,
does not require any maintenance,
is durable and long-lasting,
improves a shopping experience for all shoppers,
can hold a variety of items,
can be permanently or removably secured onto most types of shopping carts,
does not interfere with the operation of a shopping cart,
can include a variety of advertising and/or promotional materials, and indicia,
provides multiple revenue sources from advertising,
can be easily built onto new shopping carts, or retrofitted onto existing shopping carts,
is cost effective from both a manufacturer's and consumer's point of view.

These and other objects and advantages of the present invention will become apparent from the subsequent detailed description of the preferred embodiment and the appended claims taken in conjunction with the accompanying drawings.

### BRIEF DESCRIPTION OF THE DRAWINGS

FIG. 1 is an orthographic view showing a shopper's pouch with a viewing window displaying advertising indicia secured to a front location on a shopping cart.

FIG. 2 is an elevational front view showing the shopper's pouch with a flap covering an upper interior access and the viewing window displaying advertising indicia.

FIG. 3 is an elevational front view showing the shopper's pouch with a viewing window displaying advertising indicia.

FIG. 4 is an elevational front view of the shopper's pouch with a viewing structure.

FIG. 5 is an orthographic view showing the shopper's pouch secured to a shopping cart structure inside the cart, with the cart itself in between the outer surface of the pouch's back section and a securing support structure.

FIG. 6 is an elevational front view showing a placard that is attached to the shopper's pouch.

FIG. 7 is an orthographic view showing the placard attached to a front surface of the shopper's pouch, and the pouch and placard secured to a front location on a shopping cart.

FIG. 8 is an orthographic view showing multiple shopper's pouches with advertising secured to various locations on a shopping cart.

FIG. 9 is an elevational front view showing the shopper's pouch with a frame for displaying advertising indicia.

FIG. 10 is an elevational front view showing the shopper's pouch comprising a rigid structure with a front section, a right side wall, a left side wall, and a lower surface, attachment means securing the structure to a shopping cart, and a front advertising placard.

FIG. 11 is an elevational side view showing the shopper's pouch comprising a rigid structure with a front section, a right side wall, a left side wall and a lower surface, attachment means securing the structure to a shopping cart, and a front advertising placard.

FIG. 12 is an elevational front view showing the shopper's pouch comprising a rigid structure with a convex front section and a lower surface, attachment means securing the structure to a shopping cart, and a front advertising placard.

FIG. 13 is an orthographic view showing the shopper's pouch comprising a rigid structure with a convex front section and a lower surface, attachment means securing the structure to a shopping cart, and a front advertising placard.

FIG. 14 is an elevational side view showing the shopper's pouch comprising a rigid structure with a convex front section and a lower surface, and attachment means securing the structure to a shopping cart.

FIG. 15 is an elevational front view showing the shopper's pouch extending upward from a lower edge of the front section of a shopping cart's basket.

FIG. 16 is an elevational side view showing the shopper's pouch extending upward from a lower edge of the front section of a shopping cart's basket.

### BEST MODE FOR CARRYING OUT THE INVENTION

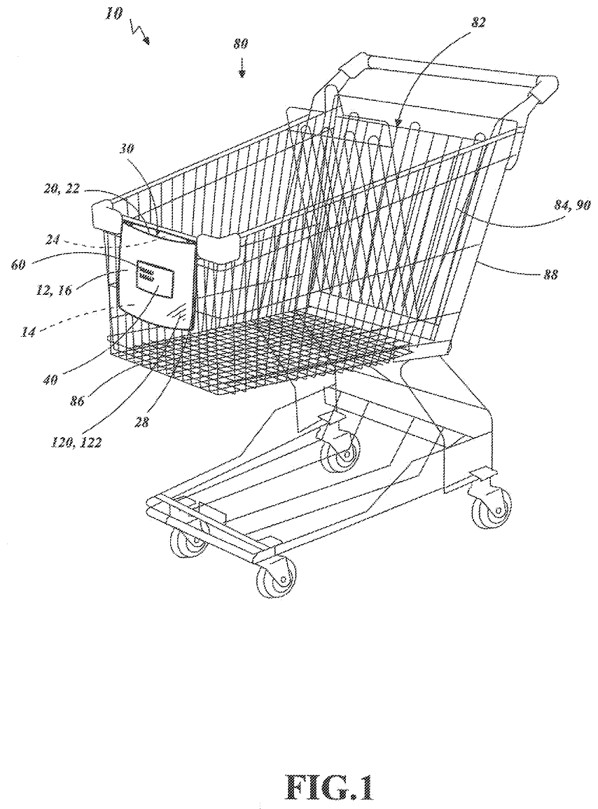

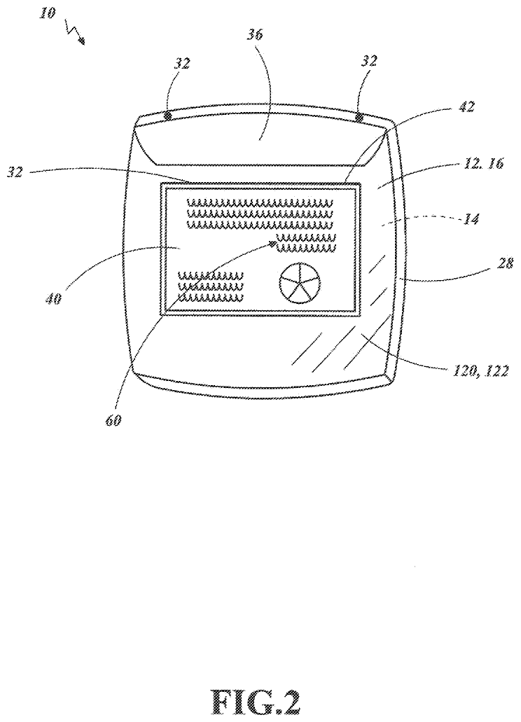

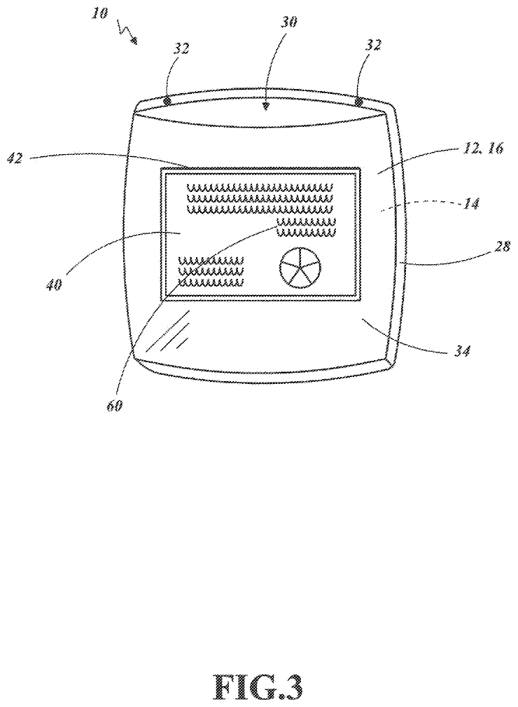

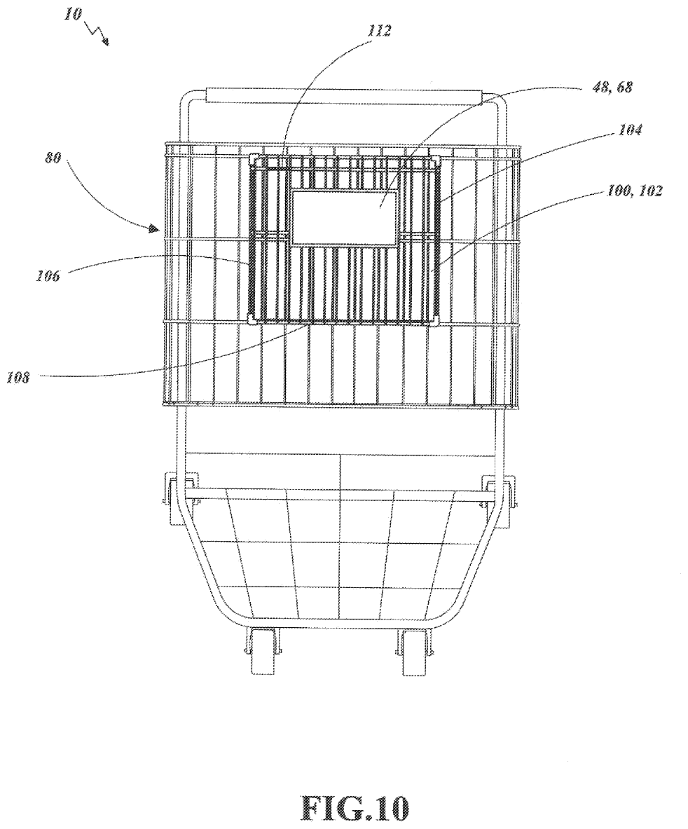

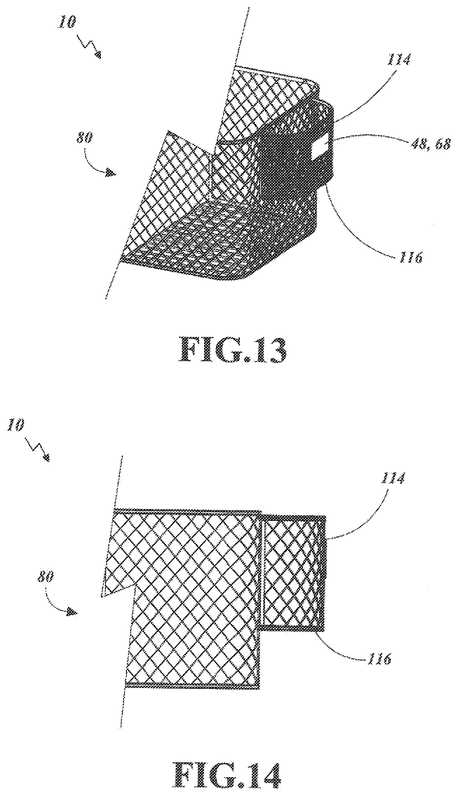

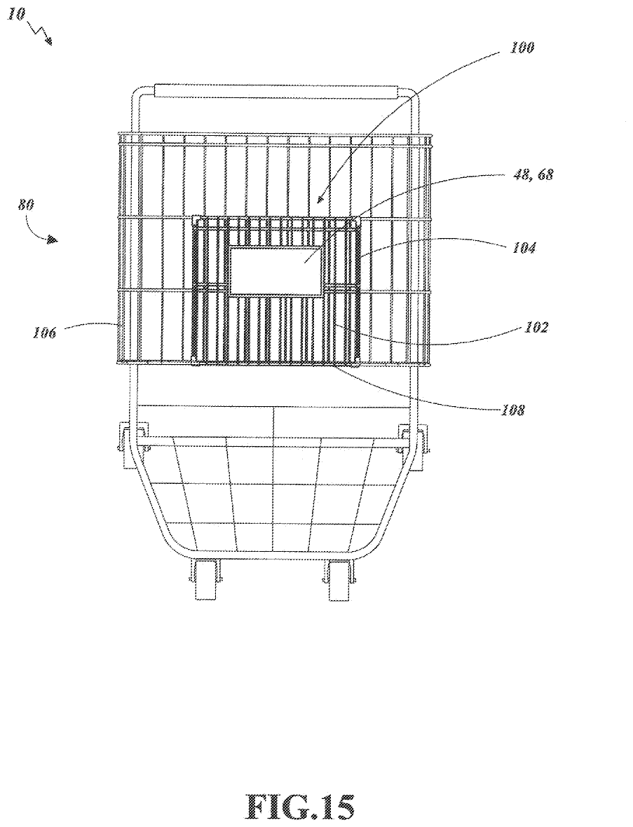

The best mode for carrying out the invention is presented in terms that disclose a preferred embodiment of a shopper's pouch. When shopping at a supermarket or other store it is common to use a shopping cart for maintaining items that will be purchased at the conclusion of shopping. In addition to items that will be purchased, many shoppers bring personal items with them. These personal items must either be carried or placed within the shopping cart along with the items to be purchased. A widely seen personal item that is now brought especially to a supermarket is re-usable shopping bags. Unfortunately, the shopping bags are often awkward or difficult to carry or place in a shopping cart. The shopper's pouch offers a solution to this problem by providing a storage means that is attached to a shopping cart and can hold shopping bags or other items while a person is shopping and allows the bags or items to be quickly and easily removed when needed. The shopper's pouch 10, as shown in FIGS. 1-16, is essentially comprised of three major elements: a front section 12, a rear section 20, and a lower section 28. The pouch can be a variety of shapes, but a substantially square shape is preferred and for the purpose of this disclosure a square shape pouch will be described and shown. The front section 12 has an inner surface 14 and an outer surface 16. The rear section 20 also has an inner surface 22 and an outer surface 24. As shown in FIGS. 1-8, both sections 12,20 can be made of a fabric, plastic, cardboard, rubber, vinyl, metal, fiberglass, or a mesh material, as shown in FIG. 10. When the pouch 10 is made of a fabric, the pouch is a pliable structure, and when the pouch 10 is made of plastic, wood, cardboard, metal, fiberglass or a composite, the pouch is typically rigid. Additionally, when the pouch is made from any of the pliable materials or rigid materials, the lower section can be made of the mesh material, which allows dirt, debris or fluid to escape from the pouch. Regardless of the material used, the pouch's 10 general design and functionality is the same. The pouch is actually a rectangle, and the front and rear sections can have the same dimensions with the lower section 28 present, or the two sections can be sized differently. To protect the pouch 10 during inclement weather or against accidents, the three sections 12,20,28 can have a fluid-resistant coating 120, as shown in FIGS. 1, 2 and 11, applied, or the sections can be made of a fluid-resistant material. The front section 12 and rear section 20 have the same dimensions and together create a pouch or bag. An upper interior access 30 is an opening preferably located on the top of the pouch to allow items to be placed inside the pouch. While the interior access 30 is preferably at the top of the pouch, the access 30 can also be located on either side of the pouch. As shown in FIG. 2, an upper flap 36 can be folded over the interior access 30 to fully enclose items within the pouch 10.

The shopper's pouch 10 is permanently or removably secured onto a shopping cart 70 by attachment means 32 or an attachment made of plastic, wood or metal. There are multiple effective permanent or removable attachment means 32 that can be utilized including an adhesive such as glue or epoxy, screws, bolts and nuts, clips, pins, male and female detents, hook and loop fastener, staples (or similar means that are force pressed through the pouch into the shopping cart). The type of attachment means used determines whether the shopper's pouch is permanently or removably secured onto a shopping cart. Preferably, the pouch 10 is secured to a front area 86 of a shopping cart 80, as shown in FIG. 1. Alternately, the pouch 10 can be secured to a rear area or on either side of a shopping cart 80. If desired, multiple pouches 10 can be placed on a single shopping cart 80 both inside and outside of the cart itself.

To increase the functionality of the shopper's pouch, and to provide a source of revenue derived from the pouch 10, a viewing window 40, as shown in FIGS. 1-3, and 5, can be utilized to display advertising or promotional material. The viewing window 40 is preferably located on the outer surface of the front section 12. Located along an upper edge of the window 40 is a window opening 42, as shown in FIGS. 1-3, and 5, which is essentially an access point that allows the advertising or promotional material to be inserted through the opening into a location between the outer surface of the front section 12 and the viewing window 40. Once inserted, the advertising or promotional material can be seen through the viewing window. While the window opening 42 is preferably located at the top of the viewing window 40, the opening 42 could also be located on either side of the window 40.

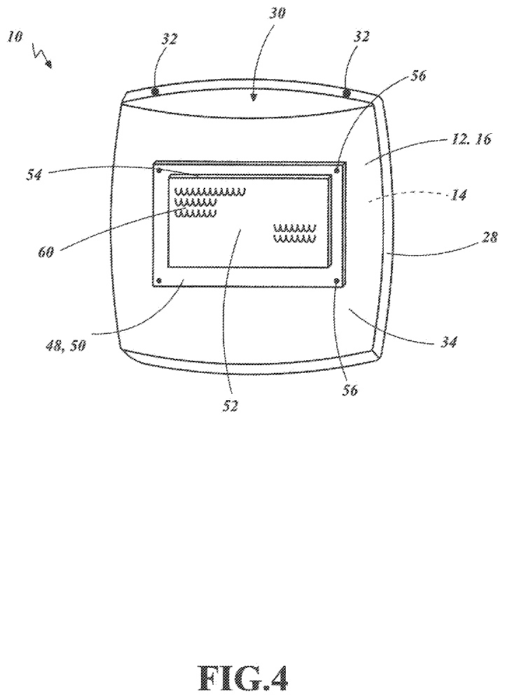

In an alternate design, a viewing structure 48, as shown in FIG. 4, can be utilized. The viewing structure 48 has a rear section 50 that can include a front transparent section 52. An opening 54 is located on the upper edge or a side edge of the viewing structure 48 and allows the insertion of advertising or promotional material into the viewing structure. As can be seen, the major differences between the viewing window 40 and viewing structure 48, is that the viewing window 40 is an integral element of the shopper's pouch 10, and the viewing structure 48 is separate from the pouch 10. Functionally, the viewing window 40 and viewing structure 48 are identical. Since the viewing structure 48 is separate, the structure 48 is secured to the shopper's pouch 10 by dedicated attachment means 56 which, as with the viewing window, can include an adhesive, screws bolts and nuts, staples, plastic connectors or zip ties. As a result of its design, the viewing structure 48 alone, without the pouch can be secured to an interior 82 or exterior 84 location, at a front 86 or rear 88 area of a shopping cart 80.

If desired, in use along with the viewing window 40 or viewing structure 48, or in lieu of these, indicia 60 can be placed on the outer surfaces of the shopper's pouch 10. It should be noted that while both the indicia and advertising or promotional material can include product advertising, business advertising, special offers, coupons, store directory, promotional events and promotional games, the indicia can also include images or writing simply for aesthetic or decorative purposes. Also, the advertising or promotional material in the viewing window or viewing structure is easily removed and replaced, and the indicia is typically permanent.

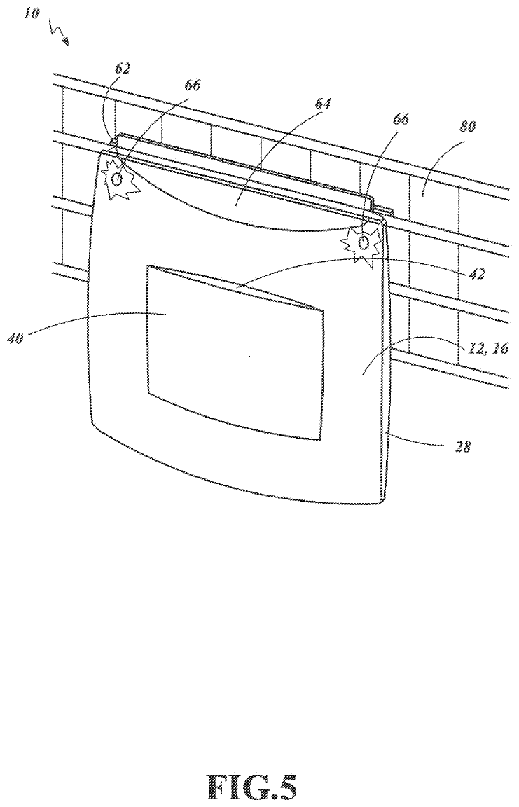

To increase the securement of the shopper's pouch to a shopping cart 70, a first securing member 62 and a second securing member 64 can be utilized. As shown in FIG. 5, the securing members 62,64 can be permanently or removably configured and are each comprised of a rigid strip that is located at an upper area within the shopper's pouch. The first securing member 62 is located inside the pouch, at the top of the rear section, or just below the flap's fold line and the second securing member 64 is placed on the opposite side of the shopping cart depending on whether the pouch is configured on the interior or exterior of a shopping cart. The members 62,64 are made of metal, wood or plastic and are longitudinally secured by attachment means 66 to each other, with the shopper's pouch and the cart sandwiched between the securing members 62,64. The attachment means 66, as shown in FIG. 5, can be comprised of screws, bolts and nuts or any means that extends through the members 62,64 and the pouch 10. Once secured, the members 62,64 firmly maintain the shopper's pouch 10 in position on the shopping cart 70.

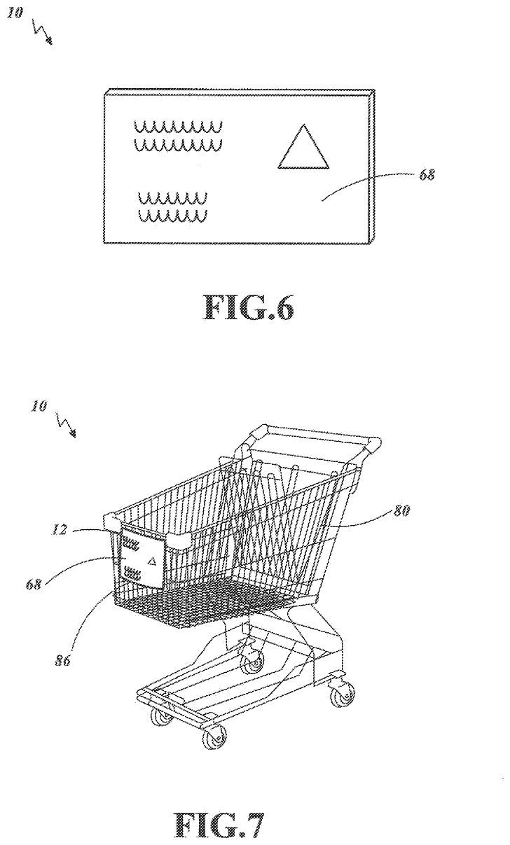

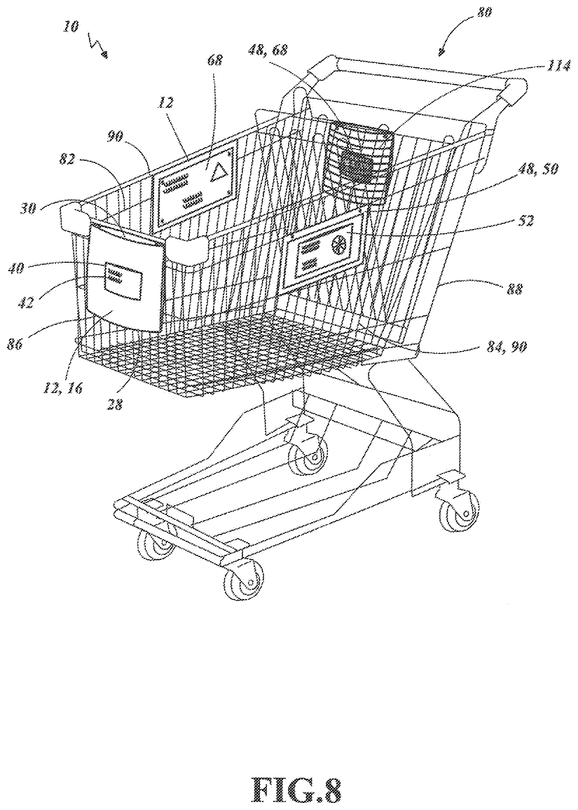

As shown in FIGS. 6-8, to provide additional display space for advertising, promotional or indicia in general, a second placard 68 can be used. The placard 68 is preferably configured to extend downward from the support member 64 securing the pouch to the shopping cart. The placard 68 displays indicia that is viewable by a person pushing the shopping cart from the rear of the shopping cart. While the placard 68 is preferably configured on the interior 82 of a shopping cart 80, as shown in FIG. 8, the placard 68 can also be configured on the exterior 84, either at the front 86, as shown in FIG. 7, or rear 88 of a shopping cart, or on one (or both) of the sides of a shopping cart depending upon the pouch's location.

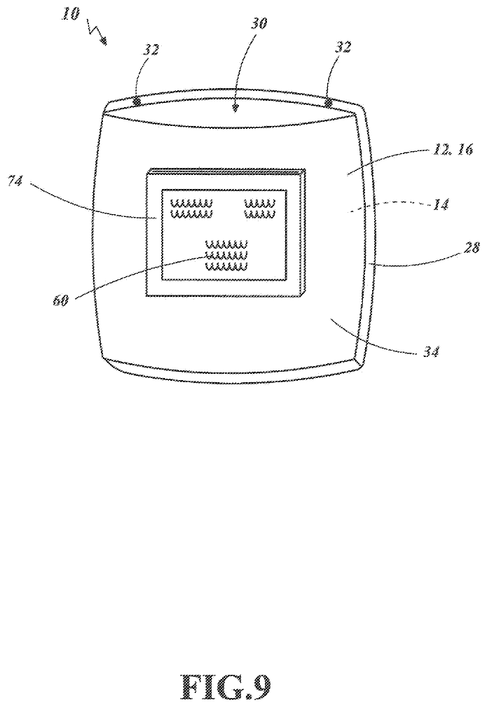

As shown in FIG. 9, as an alternate advertising display means, an advertising frame 74 without a viewing window can be utilized. The frame 74 an be any shape, but for the purpose of this disclosure a square shape frame with four sides is described and shown. Located on an upper side or one of the side edges is a slot into which can advertising medium such as a paper with indicia thereon can be inserted. On a side opposite the slot there is a lip that functions as a support member 76 for the advertising medium within the frame. Once the advertising is inserted into the frame through the slot, the advertising can be viewed by a person pushing the shopping cart or proximate to the shopping cart, depending on the location of the advertising frame.

It should be noted that any of the designs of the shopper's pouch, with or without advertising can be used singularly on a shopping cart, or with multiple advertising in various locations at the interior 82 or exterior 84, on the front 86, rear 88 or side(s) 90 of the shopping cart 80, as shown in FIG. 8. Two or more of the shopper's pouch, with or without advertising can be used on a single shopping cart. As previously disclosed, multiple shopper's pouches can be used at any of the previously disclosed locations in/on a shopping cart.

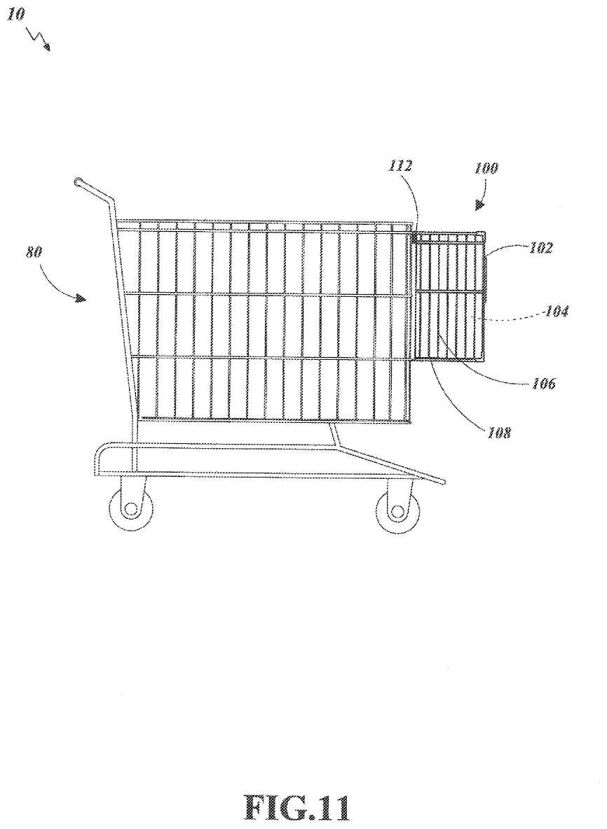

In a first alternate configuration, the shopper's pouch can comprise a rigid structure 100, as shown in FIG. 11, with a front section 102, a right wall 104, a left side wall 106, and a lower surface 108. The shopping cart's grid surface preferably functions as a rear section for the rigid structure 100, although a separate rear section can be included if desired or required. To ensure rigidity, the structure is made of metal, plastic, cardboard, wood, fiberglass or a composite. The structure extends outward from a surface of a shopping cart and when the rigid structure is made of metal or plastic, the structure can be integrally molded with the shopping cart during the cart's manufacture. In lieu of integral molding, the rigid structure 100 can be secured to a shopping cart 90 by attachment means including an adhesive, such as glue or epoxy, screws, bolts and nuts, clips, pins, male and female detents, hook and loop fasteners, and staples. As with the previous configurations, depending on the attachment means 112 used, the shopper's pouch can be permanently or removably secured onto a shopping cart.

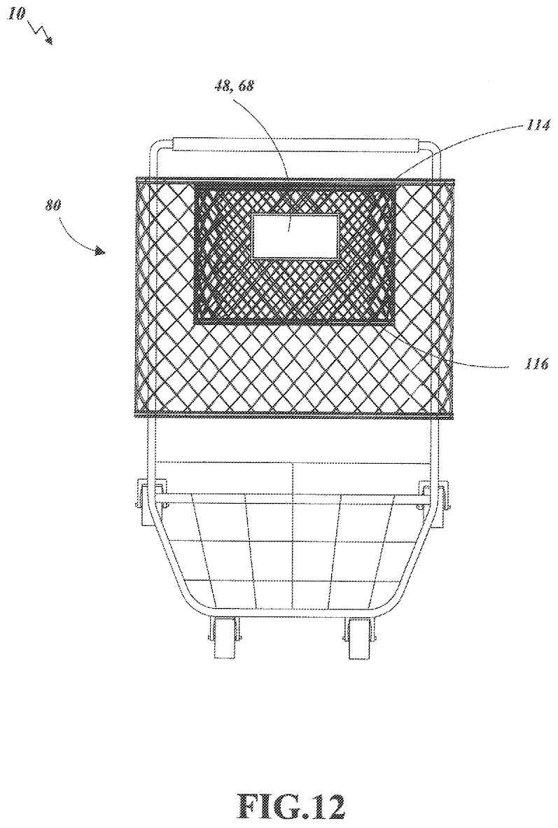

A second alternate configuration of the shopper's pouch also comprises a rigid structure 100 but this configuration only has a convex front section 114 and a lower surface 116, as shown in FIG. 12. As with the first alternate configuration, the shopping cart's grid surface preferably functions as rear section, although a separate rear section can be included if desired or required. The convex rigid structure can be integrally molded with the shopping cart 90 when the structure 100 is made of metal, or can be secured by the attachment means 112 when made of plastic, wood, fiberglass or a composite.

As previously disclosed, for any of the shopper's pouch configurations, a fluid-resistant coating 120 can be either applied to the material, or a fluid-resistant material can be utilized. Additionally, an anti-microbial material can be utilized or an anti-microbial agent 122 can be applied onto the shopper' pouch.

It should be noted that the two most viable, and therefore preferable designs of the shopper's pouch 10 are the rigid, square/rectangular structure with a front section, a right side wall, a left side wall and a lower surface, as shown in FIGS. 10-11, or the rigid structure with a convex front section and a lower surface, as shown in FIGS. 12-14. Both designs also have an upper interior access for placing items into or removing items from the shopper's pouch. Depending on the material used to make either of these designs, both permanent or non-permanent attachment means, as previously disclosed, can be utilized to secure the shopper's pouch onto a shopping cart. For example, a metal shopper's pouch can be welded to a metal shopping cart or a plastic shopper's pouch can be heat-molded onto a plastic shopping cart for permanent attachment. For either a metal or plastic shopper's pouch, male and female detents, or hook and loop fastener can provide non-permanent securement.

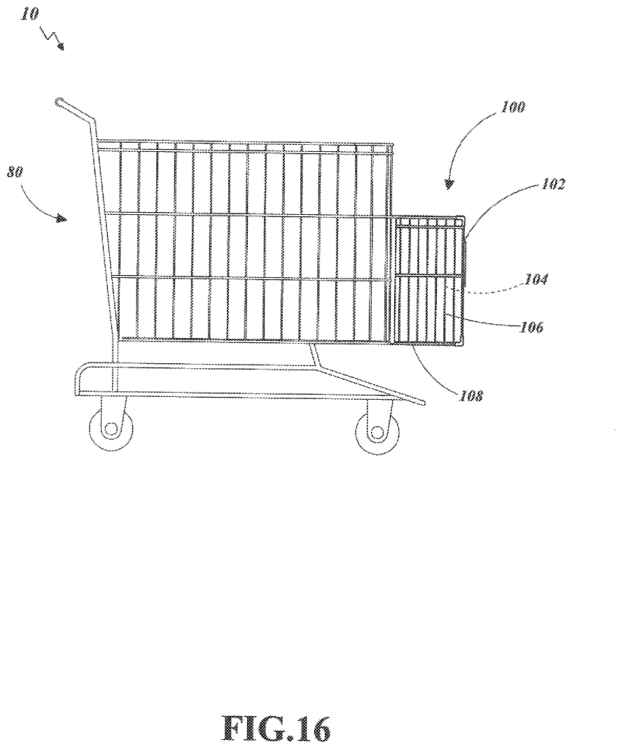

Additionally, the shopper's pouch is preferably located extending downward from an upper edge of a front (or other) section of a shopping cart, with the pouch's upper interior access essentially on the same plane as the open top of a shopping cart. If desired, or required, the shopper's pouch can extend upward from a lower edge of a front or any other section of a shopping cart, as shown in FIGS. 15 and 16.

Although the designs disclosed above are viable, other designs and/or attachment means could also be utilized. For example, on the non-rigid pouch, a piece of material such as polypropylene with a front and rear surface can be used. The upper section of the material is attached to a rubber strip, while allowing the rubber strip to slightly expand. The rubber strip is bonded to two metal pieces that are attached, preferably by welding onto the front or either side of the shopping cart. Optimally, each metal piece is fabricated as a 90-degree piece that is welded to the front or side. The rubber strip is located on the front only to reduce friction. There is no lower surface (bottom) so a person cannot place or slide any item into the pouch, thereby avoiding theft of the item. This also removes the need for a transparent vinyl window. The lower section of the pouch simply hangs downward or securing means such as clips can be used to attach the sides of the pouch to the shopping cart. The polypropylene material is made large enough to allow advertisement to be placed thereon.

While the invention has been described in detail and pictorially shown in the accompanying drawings it is not to be limited to such details, since many changes and modification may be made to the invention without departing from the spirit and the scope thereof. Hence, it is described to cover any and all modifications and forms which may come within the language and scope of the claims.

1. A shopper's pouch comprising a front section configured with an inner surface and an outer surface, a rear section configured with an inner surface and an outer surface, a perimeter, a lower section, an upper interior access, and attachment means to secure the shopper's pouch onto a structural component of a shopping cart.

2. The shopper's pouch of claim 1, wherein the pouch is made of a material selected from the group consisting of fabric, plastic, fiberglass, cardboard, rubber, vinyl, metal and mesh.

3. The shopper's pouch of claim 2, wherein the material is anti-microbial.

4. The shopper's pouch of claim 2, wherein the material is configured with an anti-microbial agent applied thereto.

5. The shopper's pouch of claim 2, wherein the material is fluid-resistant.

6. The shopper's pouch of claim 2, wherein the material is configured with a fluid-resistant coating applied thereon.

7. The shopper's pouch of claim 2, wherein the attachment means are selected from the group consisting of an adhesive, screws, bolts and nuts, pins, male and female detents, hook and loop fasteners, welds, clips, clamps and staples.

8. The shopper's pouch of claim 2, further comprising a viewing window made of transparent plastic and configured on the outer surface of the front section, wherein the viewing window comprises a window opening that facilitates the insertion of advertising or promotional material between the outer surface of the front section and the viewing window, thereby allowing the advertising or promotional material to be viewed through the window.

9. The shopper's pouch of claim 2, further comprising indicia that is configured on the outer surface of the front section.

10. A shopper's pouch comprising a front section, a right side wall with an inner surface and outer surface, a left side wall with an inner surface and outer surface, a lower surface, and an upper interior access, with attachment means securing the shopper's pouch onto a structural component of a shopping cart.

11. The shopper's pouch of claim 10, wherein the material is configured with an anti-microbial agent applied thereto.

12. The shopper's pouch of claim 10, wherein the attachment means are selected from the group consisting of an adhesive, screws, bolts and nuts, pins, male and female detents, hook and loop fasteners, welds, clips, clamps and staples.

13. The shopper's pouch of claim 10, further comprising a viewing window made of transparent plastic and configured on the outer surface of the front section, wherein the viewing window comprises a window opening that facilitates the insertion of advertising or promotional material between the outer surface of the front section and the viewing window, thereby allowing the advertising or promotional material to be viewed through the window.

14. The shopper's pouch of claim 10, further comprising indicia that is configured on the outer surface of the front section.

15. A shopper's pouch that is permanently secured by attachment means onto a horizontal structural component of a shopping cart, the shopper's pouch comprising:
a front section configured with an inner surface and an outer surface,
a rear section configured with an inner surface and an outer surface,
a perimeter,
an upper interior access and,
a viewing window made of transparent plastic and configured on the outer surface of the front section, the viewing window comprising a window opening that facilitates the insertion of advertising or promotional material between the outer surface of the front section and the viewing window, thereby allowing the advertising or promotional material to be viewed through the window.

16. The shopper's pouch of claim 15, wherein the material is anti-microbial.

17. The shopper's pouch of claim 15, wherein the material is configured with an anti-microbial agent applied thereto.

18. The shopper's pouch of claim 15, wherein the material is fluid resistant.

19. The shopper's pouch of claim 15, wherein the material is configured with a fluid resistant coating applied thereon.

20. The shopper's pouch of claim 15, wherein the attachment means for securing the shopper's pouch to a structural component of a shopping cart are selected from the group consisting of an adhesive, screws, bolts and nuts, pins, male and female detents, hook and loop fasteners, welds, clips, clamps and staples.

21. The shopper's pouch of claim 15, wherein the advertising or promotional material is selected from the group consisting of product advertising, business advertising, special offers, coupons, store directory, promotional events, and promotional games.

22. The shopper's pouch of claim 15, further comprising indicia that is configured on the outer surface of the front section of the shopping pouch.

23. The shopper's pouch of claim 15, further comprising a first securing member and a second securing member each configured as a rigid strip located at an upper area within the shopper's pouch, wherein the first securing member and second securing member are positionally aligned with the shopper's pouch and shopping cart and are sandwiched between the first and second securing members, wherein the first and second members with shopper's pouch extending from the two members are longitudinally secured by attachment means to structural component on an interior or exterior, front or side surface of the shopping cart, thereby securing the shopper's pouch to the shopping cart, wherein the attachment means are selected from the group consisting of an adhesive, screws, bolts and nuts, pins, ties, hook and loop fastener, male and female detents and staples.

24. A shopper's pouch that is permanently secured by attachment means onto a shopping cart, the shopper's pouch comprising:
a front section,
a left side section,
a right side section,
a lower section,
an upper interior access, and
a viewing window made of transparent plastic and configured on the outer surface of the front section, the viewing window comprising a window opening that facilitates the insertion of advertising or promotional material between the outer surface of the front section and the viewing window, thereby allowing the advertising to promotional material to be viewed through the window.

25. The shopper's pouch of claim 24, wherein the material is configured with an anti-microbial agent applied thereto.

26. The shopper's pouch of claim 24, wherein the attachment means for securing the shopper's pouch to a structural component of a shopping cart are selected from the group consisting of an adhesive, screws, bolts and nuts, pins, male and female detents, hook and loop fasteners, welds, clips, clamps and staples.

27. The shopper's pouch of claim 24, wherein the advertising or promotional material is selected from the group consisting of product advertising, business advertising, special offers, coupons, store directory, promotional events, and promotional games.

28. The shopper's pouch of claim 24, further comprising indicia that is configured on the outer surface of the front section of the shopping pouch.

29. The shopper's pouch of claim 24, wherein the pouch is secured by attachment means to a structural component on an interior or exterior, front or side surface of shopping cart, thereby securing the shopper's pouch to the shopping cart, wherein the attachment means are selected from the group consisting of an adhesive, screws, bolts and nuts, pins, ties, hook and loop fastener, male and female detents, welds, clips, clamps and staples.

30. The shopper's pouch of claim 24, wherein the pouch comprises a convex front section and a lower surface, and is permanently secured by attachment means to a shopping cart.

31. The shopper's pouch of claim 24, wherein the structure is integrally molded with a shopping cart during manufacture.
